(19) United States
(12) Patent Application Publication
(10) Pub. No.: US 2026/0211591 A1
(43) Pub. Date: Jul. 23, 2026

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Tetsuya KOBAYASHI, Kanagawa (JP)

(73) Assignee: FUJIFILM Business Innovation Corp., Tokyo (JP)

(21) Appl. No.: 19/309,752

(22) Filed: Aug. 26, 2025

(30) Foreign Application Priority Data
Jan. 22, 2025 (JP) 2025-009379

(51) Int. Cl. G06F 3/12

(52) U.S. Cl. CPC G06F 3/1222; G06F 3/1238

(57) ABSTRACT

An information processing system includes a processor configured to perform control of: receiving a print instruction for a print job; acquiring, based on the received print instruction for the print job, the print job from a first apparatus in which the print job is registered while maintaining a predetermined first security level; and outputting the acquired print job to a second apparatus configured to execute print processing at a second security level lower than the first security level.

### CROSS-REFERENCE TO RELATED APPLICATIONS

This application is based on and claims priority under 35 USC 119 from Japanese Patent Application No. 2025-009379 filed January 22, 2025.

### BACKGROUND

### Technical Field

The present disclosure relates to an information processing system and a non-transitory computer readable medium.

### Related Art

Japanese Unexamined Patent Application Publication No. 2023-39264 discloses an information processing apparatus that switches a storage destination of a print job depending on whether a print instruction is given by a remote operation. The information processing apparatus includes a determination unit configured to determine whether an instruction for printing based on a print job is given by a remote operation. The information processing apparatus includes a decision unit configured to decide one of apparatuses belonging to a local network, to which the information processing apparatus belongs, as a storage destination of the print job in accordance with a result of the determination by the determination unit.

### SUMMARY

When a job is to be stored in an external storage device and the job stored in the external storage device is to be acquired and printed by a designated printer, the printing needs to be performed while maintaining the security of the job. Such printing of a job while maintaining security may be achieved through printing by a printer in a security environment in which security can be maintained. However, a user who issues the print instruction may request for the printing of a job at any one of a plurality of locations where the user can be at. In this case, when the security is insufficient for the printing of a job by the printer requested by the user to perform the printing, the job cannot be acquired from the external storage device. Thus, the printing of the job is difficult. To solve this problem, the print target printer may be switched to a printer capable of performing the printing while maintaining security, a job may be acquired from the external storage device, and printing of the job may be executed. However, this increases the burden on the user.

Aspects of non-limiting embodiments of the present disclosure relate to an information processing system and a non-transitory computer readable medium that are capable of reducing a burden on a user compared with a case where switching is performed to a printer capable of executing printing while maintaining security.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor, the processor being configured to perform control of: receiving a print instruction for a print job; acquiring, based on the received print instruction for the print job, the print job from a first apparatus in which the print job is registered while maintaining a predetermined first security level; and outputting the acquired print job to a second apparatus configured to execute print processing at a second security level lower than the first security level.

### BRIEF DESCRIPTION OF THE DRAWINGS

Exemplary embodiments of the present disclosure will be described in detail based on the following figures, wherein:

FIG. 1 is a diagram illustrating an example of a schematic configuration of an information processing system according to a first exemplary embodiment;

FIG. 2 is a diagram illustrating an example of a schematic electric configuration of a computer according to the first exemplary embodiment;

FIG. 3 is a diagram illustrating an example of a schematic electric configuration of an image forming apparatus according to the first exemplary embodiment;

FIG. 4 is a flowchart illustrating an example of a flow of processing by an agent program of the computer according to the first exemplary embodiment;

FIG. 5 is a diagram illustrating an example of a schematic configuration of an information processing system according to a second exemplary embodiment;

FIG. 6 is a flowchart illustrating an example of a flow of processing by an agent program of a computer according to the second exemplary embodiment;

FIG. 7 is a diagram illustrating an example of a schematic configuration of an information processing system according to a third exemplary embodiment; and

FIG. 8 is a flowchart illustrating an example of a flow of processing by an agent program of a computer according to the third exemplary embodiment.

### DETAILED DESCRIPTION

Hereinafter, exemplary embodiments for implementing the technique of the present disclosure will be described in detail with reference to the drawings. Components and processes having the same operations, effects, and functions are denoted by the same reference numerals throughout the drawings, and a repetitive description thereof may be omitted as appropriate. The drawings are merely schematic views sufficient for full understanding of the technique of the present disclosure. Therefore, the technique of the present disclosure is not limited to the illustrated examples. In the present exemplary embodiments, descriptions on configurations that are not directly related to the present disclosure or well-known configurations may be omitted.

### First Exemplary Embodiment

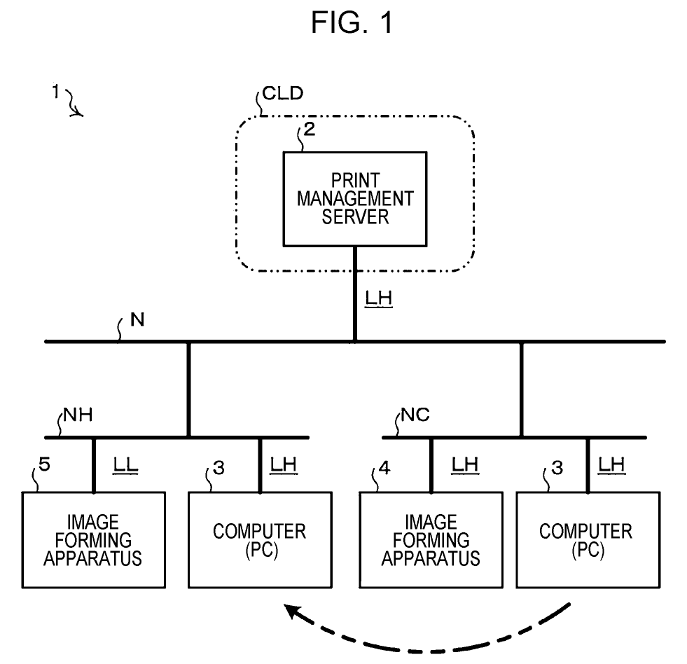

FIG. 1 is a diagram illustrating an example of a schematic configuration of an information processing system according to an exemplary embodiment for implementing the technique of the present disclosure.

The information processing system 1 according to the first exemplary embodiment includes a print management server 2 that is constructed on a cloud network CLD and provides a print management service. The print management server 2 is connected to a network N. For the network N, a public communication line, such as the Internet or a telephone network, or a public network, such as a local area network (LAN) or a wide area network (WAN) is used. Furthermore, for the network N, a public network such as a communication line for at least one of wired communication and wireless communication may be used.

The print management server 2 is constructed on the cloud network CLD and functions as an apparatus that provides various print management services to devices connected to the network N. For example, the print management server 2 is constructed on the network N using cloud computing technique and can be utilized equivalently to virtual hardware resources and software resources similar to those of devices installed in a real environment. Thus, the print management server 2 can provide various services via the cloud network CLD. While in the exemplary embodiment, the print management server 2 is described as a virtual apparatus constructed on the cloud network CLD, it is a matter of course possible that the print management server 2 can be installed in a real environment and connected to the network N.

The information processing system 1 includes portable computers (hereinafter referred to as "PC") 3 configured to be connectable to the network N via a first site network NC, and an image forming apparatus 4 including a printer or the like. The first site is a predetermined site such as a company or an organization, and a security level is set for the first site in advance. The first site network NC is a network configured to be able to exchange data, commands, and the like while maintaining the predetermined security level within the site set by a company or the like.

The information processing system 1 includes an image forming apparatus 5 configured to be connectable to a second site network different from the first site network NC. The second site is a predetermined site, such as a home or a specific location, for which a security level is set in advance. The security level is set in advance for the second site. A second site network NH is a network configured to be able to exchange data, commands, and the like while maintaining the predetermined security level within an identified predetermined site such as a home.

In the information processing system 1, the PC 3 connectable to the first site network NC is configured to be carried and moved by a user and to be connectable to the second site network NH.

The first site network NC described above can exchange commands and data while maintaining the predetermined security level. Information is exchanged between internal apparatuses in the first site connected to the first site network NC at the predetermined security level at which information leakage from the first site to the outside is suppressed. The security level during communication with the outside of the first site is similar to the security level among the internal apparatuses in the first site. Information is exchanged at the security level based on authentication information or the like set for allowing for the exchange of information. In FIG. 1, the security level during communication with the outside of the first site is illustrated as a security level LH. For example, the image forming apparatus 4, which is an apparatus in a company, having a security level set in advance, is set to be able to exchange information while maintaining the security level LH, and can acquire a print job from the print management server 2.

Similarly, the second site network NH described above can also exchange commands and data while maintaining the predetermined security level. Information is exchanged between the internal apparatuses in the second site connected to the second site network NH at the predetermined security level at which information leakage from the second site to the outside is suppressed. Since the second site is different from the first site, a security level LL different from the above-described security level LH is set as the security level for communication with the outside of the second site. According to the security level LL, it is difficult to acquire a print job from the print management server 2 without the authentication information for the security level LH. That is, for example, for the image forming apparatus 5 as an apparatus installed in a home or the like, the security level LL lower than the security level LH is set, and the connection from the image forming apparatus 5 to the print management server 2 is difficult. Thus, the image forming apparatus 5 cannot directly acquire a print job from the print management server 2.

The print management server 2 is an example of a first apparatus of the present disclosure. The image forming apparatus 5 is an example of a second apparatus of the present disclosure. The first site is an example of a first location of the present disclosure. The second site is an example of a second location of the present disclosure.

Next, a schematic electric configuration of each apparatus of the information processing system 1 according to the exemplary embodiment will be described.

The cloud network CLD and the print management server 2 have well-known configurations, and a description thereof will be omitted. As described above, the print management server 2 is configured to be able to exchange data, commands, and the like at least via the network N.

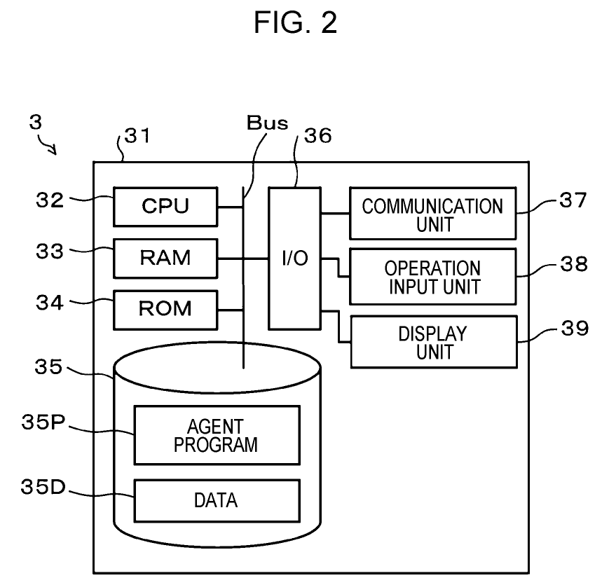

FIG. 2 is a diagram illustrating an example of a schematic electric configuration of the PC 3 according to the exemplary embodiment.

Specifically, as illustrated in FIG. 2, the PC 3 includes a computer main body 31. The computer main body 31 includes a central processing unit (CPU) 42, a random access memory (RAM) 33, a read-only memory (ROM) 34, a storage unit 35, and an input/output port (I/O) 36. The CPU 32, the RAM 33, the ROM 34, the storage unit 35, and the I/O 36 are connected to each other via a bus Bus.

A communication unit 37 that enables communication with an external apparatus, an operation input unit 38 that enables a user to perform an operation input, and a display unit 39 that enables image display are connected to the I/O 36. These functional units are capable of communicating with the CPU 32 via the I/O 36.

The computer main body 31 may be configured as a sub control unit that controls some operations of the PC 3 or may be configured as a part of a main control unit that controls all operations of the PC 3.

As the storage unit 35, for example, an auxiliary storage device such as a hard disk drive (HDD), a solid state drive (SSD), or a flash memory is used. The storage unit 35 stores an agent program 35P serving as a program according to the present disclosure. The CPU 32 reads out the agent program 35P from the storage unit 35, loads the program onto the RAM 33, and executes processing. Details of the processing by the PC 3 will be described later.

The agent program 35P may be stored in the ROM 34. For example, the agent program 35P may be installed in advance in the PC 3. The agent program 35P may be implemented by installing program information, stored in a nonvolatile storage medium or distributed through the network N, in the PC 3 as appropriate. Possible examples of the nonvolatile storage medium include a compact disc read only memory (CD-ROM), a magneto-optical disk, an HDD, a digital versatile disc read only memory (DVD-ROM), a flash memory, a memory card and the like.

The storage unit 35 also stores data 35D containing various types of information usable by the PC 3. Information for storing the data 35D is not limited to being stored in advance in the storage unit 35. For example, the information may be stored in an external apparatus (not illustrated) and acquired from the external apparatus (not illustrated) via a communication line.

The data 35D is configured to be able to temporarily store setting data related to a user who can use information processing using the PC 3.

For example, authentication information for allowing a user to utilize a service from the print management server 2 is registered in advance as the data 35D of the PC 3. The authentication information registered for each user includes, for example, a user ID and a password serving as user information, and is used for user authentication performed when a service from the print management server 2 is utilized. Therefore, the user authenticated using the authentication information authenticated, can utilize the service from the print management server 2 by using the PC 3. In order for the user to utilize the service from the print management server 2, the authentication information registered in the data 35D is assumed to be registered in advance in the print management server 2 as the authentication information for authenticating exchange of data and commands by the PC 3.

As the data 35D of the PC 3, information indicating a location where the PC 3 is physically operating, such as GPS, and information indicating a logical position of the PC 3, such as its IP address, may be stored in real time. As the information indicating the location where the PC 3 is physically operating, a location determined to be a relay point of a network device, such as a gateway, nearest to the PC 3 when the PC 3 performs communication may be used.

The communication unit 37 is connected to the networks NC and NH and is configured to enable communication between the PC 3 and other internal apparatuses and external apparatuses. As the operation input unit 38, a device for operation input, such as a keyboard or a mouse, can be used. As the display unit 39, for example, a liquid crystal display (LCD), an organic electro luminescence (EL) display, or the like is used. The display unit 39 may be integrated with the operation input unit 38, as in a case of a touch panel or the like.

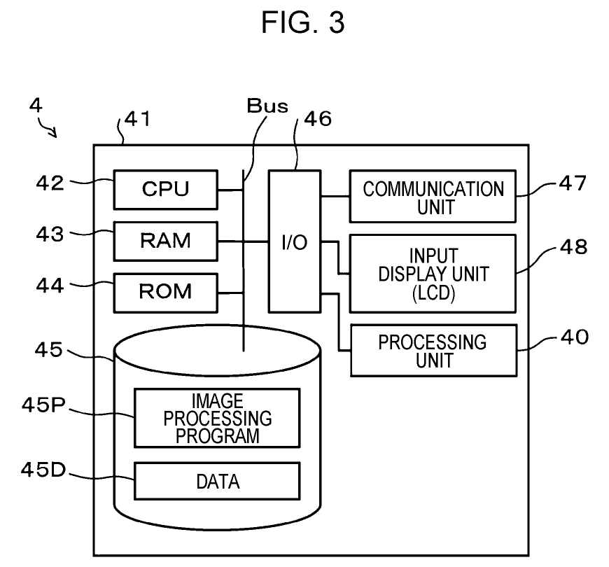

FIG. 3 is a diagram illustrating an example of a schematic electric configuration of the image forming apparatus 4 in the first site according to the exemplary embodiment.

The image forming apparatus 4 is a multifunction peripheral having some of a plurality of functions such as a copy function, a printing function, an image reading function, and an image transmission function, and in the exemplary embodiment, has at least a printing function. When the image forming apparatus 4 receives a print job related to printing from an external apparatus such as the PC 3 or the print management server 2, the image forming apparatus 4 executes print processing based on the print job.

The image forming apparatus 4 includes a computer main body 41. The computer main body 41 includes a CPU 42, a RAM 43, a ROM 44, a storage unit 45, and an I/O 46. The CPU 42, the RAM 43, the ROM 44, the storage unit 45, and the I/O 46 are connected to each other via the bus Bus.

Functional units including a communication unit 47 that enables communication with an external apparatus and an input display unit 48 that enables operation input by a user and information display are connected to the I/O 46. These functional units are capable of communicating with the CPU 42 via the I/O 46. As the input display unit 48, a liquid crystal display (LCD) configured to enable information input and output, such as a touch panel or the like, may be used.

A processing unit 40 that is related to image forming, and physically executes various functions, such as the above-described printing function, is connected to the I/O 46. The processing unit 40 executes actual image forming processing.

The storage unit 45 stores an image processing program 45P for causing the image forming apparatus 4 to function. The CPU 42 reads out the image processing program 45P from the storage unit 45, loads the program onto the RAM 43, and executes image forming processing. With this configuration, the image forming apparatus 4 can execute various types of processing related to image formation, upon executing the image processing program 45P.

The storage unit 45 also stores data 45D containing various types of information usable by the image forming apparatus 4. As the data 45D, data related to image processing executed by the image forming apparatus 4 is registered. Applicable examples of the data include the above-described user authentication information and data used for a file transfer function for exchange via a network. The data used for the file transfer function includes an IP address and a uniform resource locator (URL) indicating the location of an apparatus such as a file server and the print management server 2, and data serving as authentication information used for authentication of the apparatus.

Thus, the image forming apparatus 4 is capable of receiving a user instruction, logging into a service provided by an apparatus such as a file server or the print management server 2, and executing predetermined processing.

The communication unit 47 is connected to the first site network NC and is configured to enable the image forming apparatus 4 to communicate with internal apparatuses within the first site and with external apparatuses via the network N. The input display unit 48 receives various instructions from the user of the image forming apparatus 4 and displays various types of information, such as a result of processing executed in response to the instruction received from the user and a notification about the processing.

As described above, the image forming apparatus 4 installed in the first site can acquire a print job from the print management server 2 while maintaining a security level (the security level LH in FIG. 1). For example, the IP address and the URL indicating the location of the print management server 2 and data serving as authentication information used for authentication of the print management server 2 are set in advance in the image forming apparatus 4. Thus, the image forming apparatus 4 can acquire a print job based on a user instruction from the print management server 2 and print the print job while maintaining the security level LH.

Next, the image forming apparatus 5 installed in the second site according to the exemplary embodiment will be described. Since the image forming apparatus 5 has substantially the same schematic electric configuration as that of the image forming apparatus 4 described above, a detailed description thereof will be omitted, and only differences will be described below.

As the image forming apparatus 5, a printer having at least a printing function can be used. The above-described multifunction peripheral may be used.

The image forming apparatus 5 is an apparatus connected to the second site network NH provided to the second site such as a home. Thus, while data related to image processing executed by the image forming apparatus 5 is registered in the storage unit of the image forming apparatus 5, the above-described authentication information of a user for using the print management server 2 and the like are not stored. Thus, after receiving a print instruction from a user, the image forming apparatus 5 cannot log into a service provided by the print management server 2 to execute predetermined processing.

A user may desire to execute a print job in the second site such as a home different from the first site, in the same manner as he or she executes the print job in the first site such as a company. However, when the print job is executed in the first site such as a company, predetermined security is set, meaning that security is guaranteed for print jobs that are exchanged in the printing within the first site. On the other hand, in the second site such as a home, the setting for the predetermined security may be incomplete, meaning that security for print jobs may not be guaranteed. Thus, there is a risk of leakage of information on print job transfer.

In view of this, an information processing system according to an exemplary embodiment includes a processor, and the processor receives a print instruction for a print job. Based on the received print instruction for the print job, the processor acquires the print job from the print management server 2 in which the print job is registered while maintaining a predetermined first security level. Then, the processor performs control of outputting the print job to the image forming apparatus 5 in the second site that executes print processing at a second security level lower than the first security level. With the information processing system according to the exemplary embodiment having such a configuration, it is possible to reduce the burden on the user compared with a case where switching is performed to a printer capable of executing printing while maintaining security.

Next, operations of the information processing system 1 according to the present exemplary embodiment will be described mainly based on the processing executed by the PC 3.

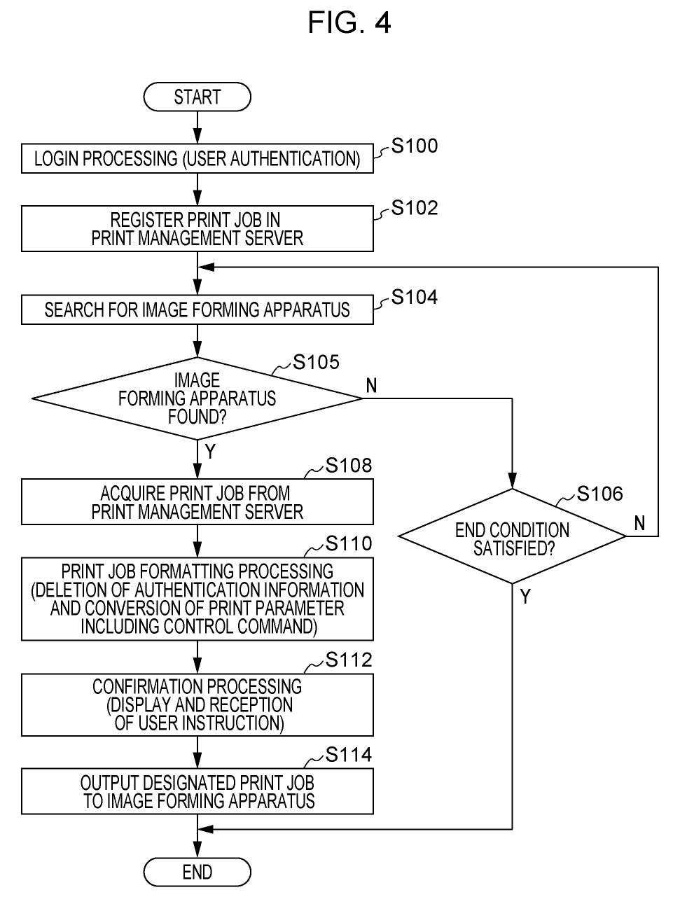

FIG. 4 is a flowchart illustrating an example of a flow of processing by the agent program 35P stored in the PC 3.

In the information processing system 1 according to the exemplary embodiment, a case where a user moves from the first site such as a company to the second site such as his/her home and connects the PC 3 to the second site network NH will be described.

Specifically, in the PC 3, the CPU 32 receives an instruction to start the agent program 35P operated by the user and executes the following steps.

First, in step S100 in FIG. 4, login processing is executed with authentication processing for the user, that is, user authentication performed. In the user authentication processing, authentication processing is executed using a user ID and a password that are registered in advance in the PC 3.

When the authentication processing fails a predetermined number of times in step S100, the present processing routine may be forcibly terminated. Alternatively, the present processing routine may be terminated after predetermined processing associated with the failure of the authentication processing is executed.

Next, when the login processing to the PC 3 is successful, in step S102, processing of registering a print target print job in the print management server 2 is executed. Specifically, the CPU 32 requests the print management server 2 for processing of logging into the print management server 2 by a registered user and processing of registering the print target print job in the print management server 2. Specifically, the PC 3 transmits the print target print job and requests the print management server 2 for the registration thereof.

The print job includes user authentication information such as a user ID and a password, print target document data, and a print parameter for the document data. The print parameter includes information indicating the function of the image forming apparatus, that is, a control command for controlling the image forming apparatus. Examples of the control command include those indicating whether to perform stapling, whether to perform multicolor printing such as color printing, whether to perform double-sided printing, and the like. Additionally, the print parameter includes print data information for the document data. As the print data information, for example, information indicating a correspondence relationship between pixel values of multiple colors and monochrome tone values can be used. With the print data information, pixel values set for multiple colors can be converted into monochrome pixel values (for example, tone values). Therefore, by using the print data information, instead of performing color printing of the document data, monochrome printing corresponding to color printing can be performed by an image forming apparatus capable of performing monochrome printing.

The print parameter is an example of information corresponding to the type of the second apparatus of the present disclosure.

Upon receiving the request from the PC 3, and executing authentication processing with the user ID and password matching those registered, the print management server 2 determines the user as the authenticated user and registers the print job in a storage unit (not illustrated). When the print job registration is completed, the print management server 2 transmits information indicating that the print job registration has been completed to the PC 3 that has requested the print job registration, thereby notifying the PC 3 of the completion of registration.

Upon receiving the registration completion notification from the print management server 2, the CPU 32 of the PC 3 searches for an image forming apparatus for a predetermined period of time. Searching for the image forming apparatus corresponds to detecting a candidate apparatus capable of being an output destination of a print job. Specifically, in step S104, the CPU 32 searches for an image forming apparatus connected to the second site network NH of a site where the PC 3 is installed, which is the second site (a home, for example) herein. In the search, the CPU 32 searches for an image forming apparatus in the second site based on the network information and the printer information. Specifically, the CPU 32 detects the network information indicating a network to which the PC 3 is connected and the printer information set in the image forming apparatus. Here, the network information indicating connection to the second site network NH and the printer information indicating installation in the second site (for example, at home) are detected, and the image forming apparatus satisfying these conditions is obtained as a search result. Here, the image forming apparatus 5 is found.

The printer information includes information indicating the presence or absence of authentication information for the image forming apparatus, and information indicating any one of a personal printer, a company printer, and a shared printer as the image forming apparatus. The network information and the printer information are registered in advance in the PC 3 and stored in the data 35D.

In step S105, the CPU 32 determines whether the image forming apparatus is found as a search result.

When no image forming apparatus is found and thus the result in determination in step S105 is NO, the CPU 32 determines whether an end condition is satisfied in step S106. As the end condition, a condition indicating that a predetermined time has elapsed may be used. The end condition can be set by the user. For example, the number of retries and a retry interval when the image forming apparatus is not found may be set as setting values. The end condition described above may be satisfied when the image forming apparatus in the first site is found. This is because when the PC 3 is installed in the first site, the processing thereafter needs not to be executed for the second site.

When the end condition is satisfied, the CPU 32 determines YES in step S106, and ends the present processing routine. When the end condition is not satisfied, the CPU 32 determines NO in step S106, and the processing returns to step S104, to continue the search for the image forming apparatus.

When the image forming apparatus is found and thus a result of the determination in step S105 is YES, the CPU 32 acquires a print job from the print management server 2 in step S108.

When a plurality of image forming apparatuses are found by the search, any one of the image forming apparatuses can be obtained as the search result in accordance with a predetermined priority. The predetermined priority may be set by the user. Alternatively, an image forming apparatus with one of the physical distance and the logical on-network distance between the PC 3 and the image forming apparatus being short may be automatically set. The information indicating the priority described above is set to the PC 3 in advance as the printer information described above and is stored in the data 35D.

When acquiring a print job, first, the CPU 32 requests the print management server 2 for presentation of the user print job. Specifically, the print management server 2 is requested to present information indicating the print job corresponding to the user ID indicating the user which is, for example, an identifier unique to the print job. In response to the request from the PC 3 (i.e., the CPU 32), the print management server 2 outputs an identifier unique to the print job to the PC 3 (i.e., the CPU 32). Upon receiving the unique identifier for the print job as a response from the print management server 2, the CPU 32 executes processing of downloading the print job corresponding to the received identifier. Specifically, the print management server 2 is requested to output the print job corresponding to the identifier received by the CPU 32. In response to the request from the PC 3 (i.e., the CPU 32), the print management server 2 outputs the print job to the PC 3 (i.e., the CPU 32). The CPU 32 downloads the print job by storing the print job, which is a response from the print management server 2, in the storage unit 35.

Here, the image forming apparatus 5 is at the security level LL, which is lower than the security level LH set for the first site (LH > LL), and thus is difficult to directly download a print job. On the other hand, the PC 3 can access the print management server 2 at the security level LH, and download a print job.

Next, in step S110, the CPU 32 executes print job formatting processing. The print job formatting processing includes execution of processing of deleting authentication information in the print job and processing of converting a print parameter containing a control command in the print job into a print parameter containing a control command for the image forming apparatus 5 as the search result described above. When the processing in step S110 ends, the print job can be printed by the image forming apparatus 5 in the second site.

With the processing of deleting authentication information in a print job, when the print target is the image forming apparatus 5 installed in the second site, such as a home, and the authentication processing is set to be not required for the image forming apparatus 5, unnecessary information is deleted. When the authentication processing is required for the image forming apparatus 5, the processing of deleting authentication information is not executed.

When the authentication information deletion processing and the conversion processing for the print parameter containing the control command end, the CPU 32 executes confirmation processing in step S112. The confirmation processing is processing of supporting processing of prompting the user to confirm the print target print job. Specifically, the CPU 32 performs control of displaying, on the display unit 39, information indicating a print job which is, for example, the above-described identifier of the print job, and printer information. The user operates the operation input unit 38 while referring to the display unit 39 to issue an instruction to select the print target print job. The CPU 32 identifies a print job instructed by the operation on the operation input unit 38 and receives the identified print job as the print target print job.

Next, in step S114, the CPU 32 outputs the received print job to the image forming apparatus 5, and ends the present processing routine.

As described above, according to the present exemplary embodiment, a print job can be acquired, while maintaining the predetermined first security level LH, from the print management server 2 in the second site such as a home, where the print job for which a print instruction has been received is registered. Thus, there is no need to prepare an image forming apparatus at the security level LH to be maintained, or to switch from an image forming apparatus at the security level LL, which is lower than the security level LH, to an image forming apparatus at the security level LH. All things considered, with the information processing system according to the exemplary embodiment, the burden imposed on the user may be reduced.

According to the present exemplary embodiment, a print parameter containing a control command in a print job is converted into a print parameter containing a control command for the image forming apparatus 5 as the print processing target, thereby further reducing the burden on the user.

### Second Exemplary Embodiment

Next, a second exemplary embodiment will be described. Since the configuration according to the second exemplary embodiment is similar to that in the first exemplary embodiment, the same parts are denoted by the same reference numerals, and a detailed description thereof will be omitted. In the second exemplary embodiment, differences from the first exemplary embodiment will be described.

In the first exemplary embodiment, a description is given on a case where registration of a print job and printing of the print job are executed in the second site network NH, using the PC 3 moved from the first site such as a company to the second site such as a home.

In the second exemplary embodiment, the PC 3 installed in the second site is connected to a PC 3A installed in the first site, and the processing of registering a print job is executed by a remote operation using so-called remote desktop.

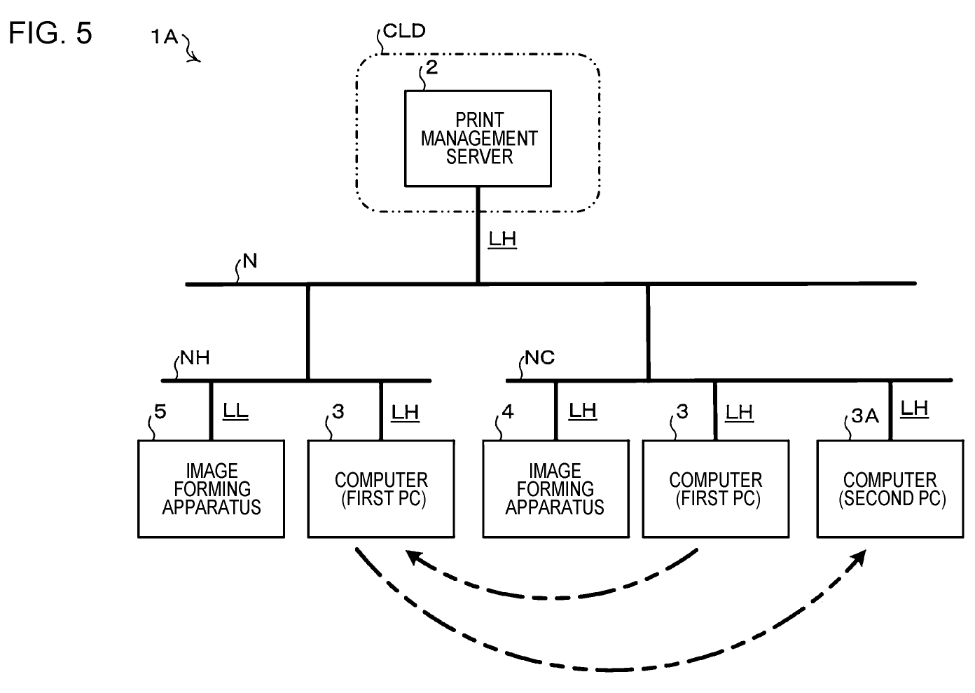

FIG. 5 is a diagram illustrating an example of a schematic configuration of an information processing system according to the second exemplary embodiment.

In an information processing system 1A according to the second exemplary embodiment, the PC 3A having a similar configuration to the PC 3 is further connected to the first site network NC of the information processing system 1 illustrated in FIG. 1. In the second exemplary embodiment, the PC 3 and the PC 3A are configured to be capable of being in remote desktop connection via the network N.

In the second exemplary embodiment, the PC 3 illustrated in FIG. 1 is referred to as a first PC 3, and the PC 3A in the remote desktop connection is referred to as a second PC 3A.

Since the configuration of the second PC 3A is similar to that of the PC 3 illustrated in FIG. 1, which is the first PC, a detailed description thereof will be omitted. When the first PC 3 and the second PC 3A are described differently in the following description, a reference sign "A" is added to the components of the first PC 3.

The second PC 3A is an example of an apparatus installed in the first location according to the present disclosure.

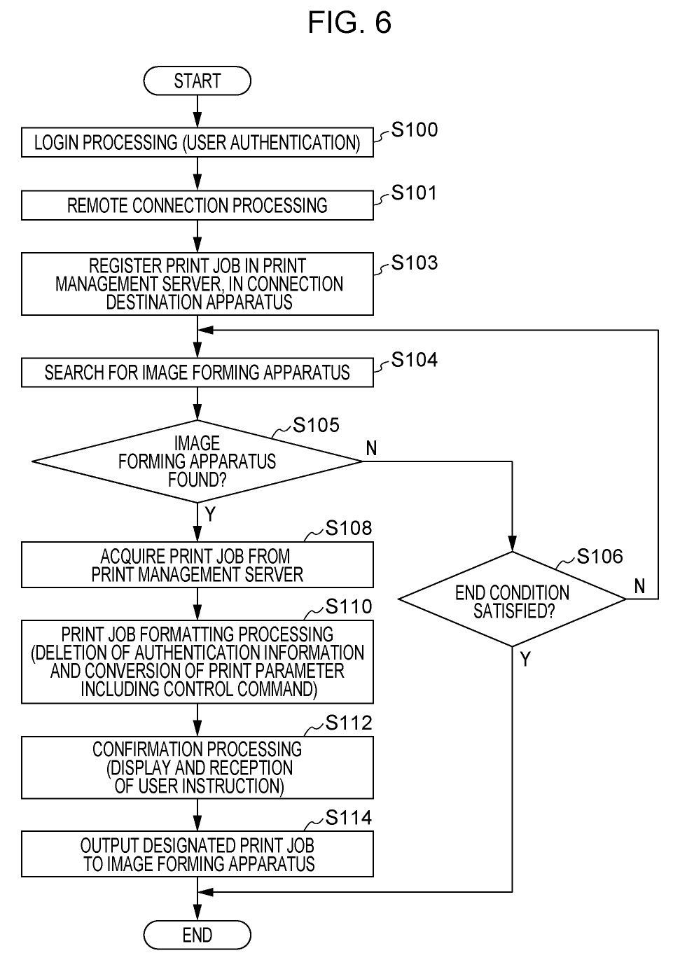

FIG. 6 is a flowchart illustrating an example of a flow of processing by the agent program 35P stored in the first PC 3 according to the present exemplary embodiment.

A description will be given on a case where in the information processing system 1 according to the present exemplary embodiment, the first PC 3 is connected to the second site network NH and is brought into remote desktop connection with the second PC 3A connected to the first site network NC.

In the processing executed by the agent program 35P illustrated in FIG. 6, the CPU 32 executes the processing in steps S101 and S103 instead of the processing in step S102 illustrated in FIG. 4.

Specifically, upon completing the login processing (i.e., user authentication) in step S100, the CPU 32 executes remote connection processing using known remote desktop connection in step S101.

Next, upon completing the remote connection processing, in step S103, the CPU 32 causes the second PC 3A to execute processing of registering the print target print job in the print management server 2. Specifically, the CPU 32 remotely operates the CPU 32A (i.e., the second PC 3A) remotely connected, and requests the print management server 2 for processing of logging into the print management server 2 by a registered user and processing of registering the print target print job in the print management server 2.

Upon receiving the request from the PC 3, and executing authentication processing with the user ID and password matching those registered, the print management server 2 determines the user as the authenticated user and registers the print job in a storage unit (not illustrated). When the print job registration is completed, the print management server 2 transmits information indicating that the print job registration has been completed to the second PC 3A that has requested the print job registration, thereby notifying the second PC 3A of the completion of registration.

The CPU 32 of the first PC 3 detects the completion of the registration of print jobs, and searches for an image forming apparatus in step S104, as described above.

Since the processing after step S105 is similar to that illustrated in FIG. 1, a description thereof will be omitted.

As described above, according to the present exemplary embodiment, a print job can be registered in the print management server 2, with remote connection to the second PC 3A in the first site from the second site, such as a home. With this configuration, the print job can be registered in the first site while maintaining the security level LH. The present exemplary embodiment is effective when registration of print jobs is limited to computers installed within the first site.

### Third Exemplary Embodiment

Next, a third exemplary embodiment will be described. Since the configuration according to the third exemplary embodiment is similar to that in the first exemplary embodiment, the same parts are denoted by the same reference numerals, and a detailed description thereof will be omitted. In the third exemplary embodiment, differences from the first exemplary embodiment will be described.

When no image forming apparatus is set in the second site, such as a home, the user may desire to execute print processing for a print job using an image forming apparatus installed in a third site, such as a convenience store, different from the first site or the second site. Furthermore, the PC 3 may be difficult to be moved from the second site to the third site.

According to the third exemplary embodiment, a mobile terminal is used to execute print processing for a print job using an image forming apparatus installed in the third site different from the first site or the second site.

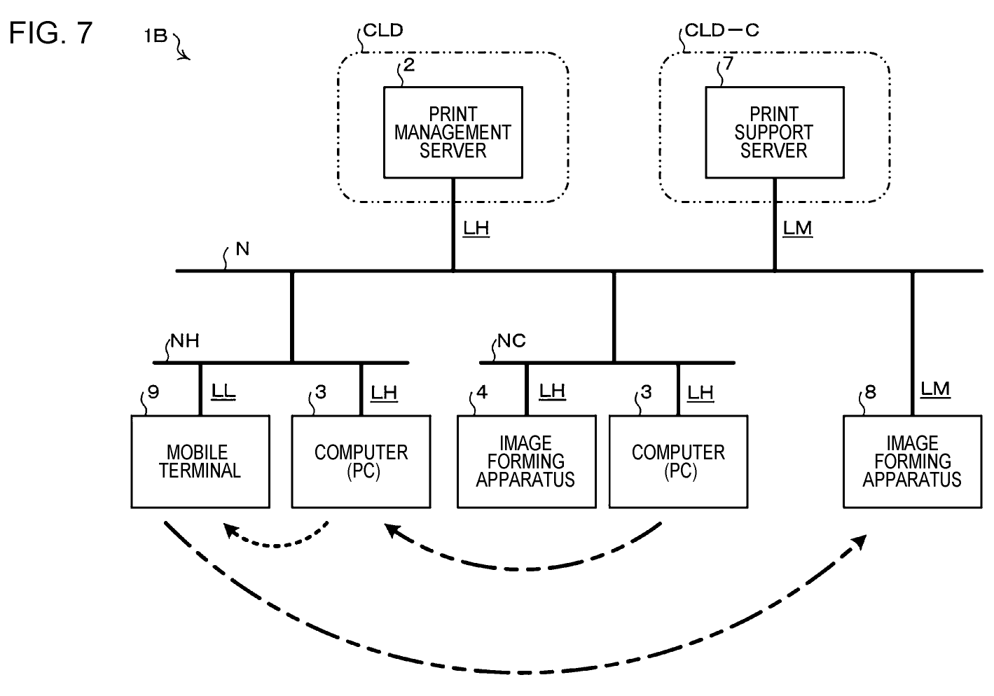

FIG. 7 is a diagram illustrating an example of a schematic configuration of an information processing system according to the third exemplary embodiment.

An information processing system 1B according to the third exemplary embodiment has a configuration in which a print support server 7 and an image forming apparatus 8 installed in the third site, such as a convenience store, are added to the information processing system 1 illustrated in FIG. 1. The information processing system 1B includes a mobile terminal 9 instead of the image forming apparatus 5, and the mobile terminal 9 is connected to the second site network NH.

Specifically, the information processing system 1B includes the print support server 7 that is constructed on a cloud network CLD-C constructed for print support and provides a print support service. The print support server 7 is connected to the network N. The print support server 7 can control the image forming apparatus 8 installed in the third site, such as a convenience store, connected via the network N.

Thus, the print support server 7 is constructed on the cloud network CLD-C sharable by users, is connected to the network N, and functions as an apparatus that provides various print support services by using the image forming apparatus managed by the print support server 7. For example, through predetermined authentication processing for the print support server 7 executed by the print support server 7, any computer (PC) and any mobile terminal, such as a smartphone or a mobile phone, can be connected to the print support server 7 via the network N.

At a security level LM different from the security levels LH and LL described above, any computer (PC) and mobile terminal can be connected to the print support server 7 constructed on the cloud network CLD-C. Thus, a print job can be registered in the print support server 7 using any computer (PC) and mobile terminal, and the registered print job can be printed by the image forming apparatus 8.

The mobile terminal 9 is an example of a third apparatus of the present disclosure. The print support server 7 is an example of a fourth apparatus of the present disclosure. The image forming apparatus 8 is an example of a fifth apparatus of the present disclosure.

The cloud network CLD-C and the print support server 7 described above have well-known configurations, and thus a description thereof will be omitted.

The mobile terminal 9 connected to the second site network NH is a terminal apparatus that is easily portable and used for issuing a print instruction in the third site. While the mobile terminal 9 has substantially the same configuration as the PC 3 described above and thus a detailed description thereof will be omitted, the mobile terminal 9 preferably has a wireless communication function, such as short-range wireless communication, and is configured to be able to wirelessly communicate with another device in a short range. Furthermore, in order to issue a print instruction in the third site, the mobile terminal 9 stores a mobile agent program and information indicating that it is a mobile terminal for printing as printer information.

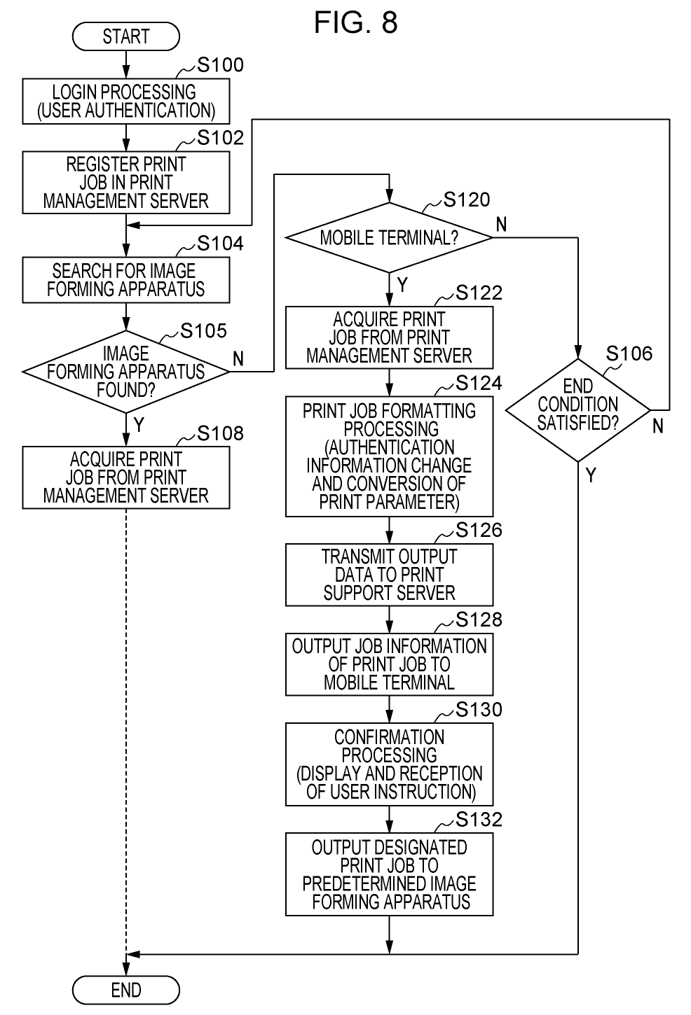

FIG. 8 is a flowchart illustrating an example of a flow of processing by the agent program 35P stored in the PC 3 according to the third exemplary embodiment.

In the processing executed by the agent program 35P illustrated in FIG. 8, the CPU 32 executes information processing in which steps S120 to S132 are added between steps S105 and S106 illustrated in FIG. 4.

Specifically, when the login processing (i.e., user authentication) is completed in step S100, as described above, in step S102, the CPU 32 of the PC 3 executes processing of registering a print job in the print management server 2. Next, upon receiving the registration completion notification from the print management server 2, the CPU 32 searches for an image forming apparatus in step S104, and determines whether an image forming apparatus is found as a search result in the next step S105. According to the present exemplary embodiment, in order to issue a print instruction in the third site, the mobile terminal 9 stores information indicating that it is a mobile terminal for printing as printer information. Thus, in the search processing in step S104, the mobile terminal 9 is detected instead of the image forming apparatus.

When the image forming apparatus is found and thus a result of the determination in step S105 is YES, the CPU 32 executes the processing in step S108 and the subsequent steps described above.

When no image forming apparatus is found and thus a result of the determination in step S105 is NO, the CPU 32 advances the processing to step S120.

In step S120, the CPU 32 determines whether the mobile terminal 9 is detected from the network information and the printer information.

When no mobile terminal 9 is detected and thus a result of the determination in step S120 is NO, the CPU 32 determines in step S106 described above whether the end condition is satisfied. When a result of this determination is NO, the processing returns to step S104. On the other hand, when a result of this determination is YES, the present processing routine ends.

When the mobile terminal 9 is detected and thus a result of the determination in step S120 is YES, in step S122, the CPU 32 acquires a print job from the print management server 2, as in step S108 described above.

Next, the CPU 32 executes formatting processing for the print job for printing in the third site in step S124. The print job formatting processing includes execution of processing of changing authentication information in the print job and processing of converting a print parameter containing a control command in the print job into a print parameter containing a control command for the image forming apparatus 8 in the third site.

The print parameter containing control commands for the image forming apparatus 8 in the third site to be used in the conversion processing is assumed to have been acquired in advance from the print support server 7. The processing of changing the authentication information in the print job in the print job formatting processing is processing of changing the authentication information to authentication information acquired in advance from the print support server 7. When the print job formatting processing ends, the print job can be registered in the print support server 7. The print job after the end of the formatting processing is a print job that can be printed by the image forming apparatus 8 in the third site.

When the print job formatting processing ends, in step S126, the CPU 32 transmits a print job including the changed authentication information and the parameter to the print support server 7 and requests for registration of the print job as output data. Next, upon receiving the registration completion notification from the print support server 7, in step S128, the CPU 32 outputs the information for authentication for usage of a service provided by the print support server 7 and the job information of the print job, for example, an identifier indicating the print target print job or the like to the mobile terminal 9.

The mobile agent program is assumed to be activated in the mobile terminal 9, that is, before the processing in step S128 is executed. The mobile agent program of the mobile terminal 9 includes processing of displaying the job information of the print job transmitted from the PC 3 and processing of transmitting a print instruction for a print job selected by the user from the displayed job information of the print job.

Next, in step S130, the CPU 32 performs, on the mobile terminal 9 side, control of executing processing of causing the user to confirm the print job. Specifically, the CPU 32 performs control of outputting the job information of the print job to the mobile terminal 9, and transfers the print job confirmation processing to the mobile terminal 9. The confirmation process is processing of causing the user to confirm the print target print job, using the mobile terminal 9. Specifically, the CPU of the mobile terminal 9 performs control of displaying, on a display unit of the mobile terminal 9, job information indicating a print job, for example, the above-described identifier of the print job, and the printer information. When the job information indicating the print job and the printer information are displayed on the display unit of the mobile terminal 9, the user can be notified of the completion of the preparation for printing of the print job. The user refers to the display unit of the mobile terminal 9 to confirm the completion of the preparation for printing the print job, and then moves to the third site where the image forming apparatus 8 is installed.

Next, while referring to the display unit of the mobile terminal 9, the user operates the operation input unit to issue an instruction to select the print target print job. The CPU of the mobile terminal 9 identifies the print job instructed by an operation on the operation input unit and receives the identified print job as the print target print job.

Next, in step S132, the CPU of the mobile terminal 9 outputs the job information of the received print job and the authentication information to the image forming apparatus 8 in the third site, and ends the present processing routine.

The image forming apparatus 8 in the third site downloads registered output data indicating the target print job from the print support server 7 using the received authentication information, and executes print processing.

As described above, according to the present exemplary embodiment, a print job can be acquired while maintaining the security level LH, and the print job can be printed in the third site, such as a convenience store. With this configuration, even when no image forming apparatus is installed in the site, a print job can be printed by using a public image forming apparatus while guaranteeing the security level to be maintained. All things considered, with the information processing system according to the exemplary embodiment, the burden imposed on the user may be reduced.

According to the present exemplary embodiment, it is possible to issue an instruction to execute a print job using the mobile terminal 9 that is light weight compared with the PC 3, and thus it is possible to further reduce the burden on the user compared with a case where the user carries the PC 3 and issues a print instruction.

### Other Exemplary Embodiments

The information processing systems according to the exemplary embodiments have been described above by way of example. The configurations of the information processing systems described in the above exemplary embodiments are merely examples, and may be modified depending on the situation without departing from the spirit of the present disclosure. The flow the processing of the program described in the above exemplary embodiments is also merely an example, and unnecessary steps may be deleted, new steps may be added, or the processing order may be changed without departing from the spirit of the present disclosure.

In the present exemplary embodiment, the processes are performed by any computer. Any computer may perform the processes by using a processor serving as hardware, a program serving as software, or a combination of these. In this case, the processor is configured to perform various processes in the present exemplary embodiments in cooperation with the program and may function as a unit or a means in the present exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor elements are combined, or the like.

Further, the program may be software such as firmware or microcode. The program may be, for example, a program module group, and the functions thereof may be implemented by processors configured to implement the respective functions. The program may be a program code or multiple code segments stored in one or more non-transitory computer readable media (such as, for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class, or any combination of instructions, data structures, or program statements. The program code or the code segments may be connected to another code segment or a hardware circuit by transmitting and/or receiving information, data, an argument, a parameter, or memory content. The program according to the present disclosure may be provided as a program product.

### Appendix

### (((1)))

An information processing system comprising a processor configured to perform control of: receiving a print instruction for a print job; acquiring, based on the received print instruction for the print job, the print job from a first apparatus in which the print job is registered while maintaining a predetermined first security level; and outputting the acquired print job to a second apparatus configured to execute print processing at a second security level lower than the first security level.

### (((2)))

The information processing system according to (((1))), wherein the print job is provided with user information indicating a user who has instructed registration of the print job, and the processor is configured to perform control of: acquiring user information indicating a user who has instructed printing of the print job; and acquiring a print job provided with user information matching the acquired user information.

### (((3)))

The information processing system according to (((1))) or (((2))), wherein the processor is configured to perform control of: detecting a candidate apparatus capable of being an output destination of the print job; determining the detected candidate apparatus as the second apparatus; and converting the print job into a print job corresponding to a type of the determined candidate apparatus as the second apparatus.

### (((4)))

The information processing system according to (((3))), wherein the processor is configured to perform control of repeatedly executing the processing of detecting the candidate apparatus for a predetermined period of time.

### (((5)))

The information processing system according to (((3))) or (((4))), wherein the processor is configured to, when a plurality of the candidate apparatuses are detected, determine any one apparatus, as the second apparatus, in accordance with a predetermined priority.

### (((6)))

The information processing system according to any one of (((1))) to (((5))), wherein the processor is configured to, upon generating information related to the print job when performing the control of acquiring and the control of outputting, perform control of deleting the information related to the print job after performing the control of outputting the print job to the second apparatus.

### (((7)))

The information processing system according to any one of (((1))) to (((6))), wherein the processor is configured to perform control of executing registration of a print job in a predetermined first location, and perform control of receiving a print instruction for the print job in a second location different from the first location.

### (((8)))

The information processing system according to (((7))), wherein the processor is configured to perform control of causing an apparatus installed in the first location to perform registration of a print job through remote connection from the second location different from the first location while maintaining a security level equal to or higher than the predetermined first security level, and to receive the print instruction for the print job in the second location.

### (((9)))

The information processing system according to any one of (((1))) to (((8))), wherein the processor is configured to perform control of: outputting information on the print instruction for the acquired print job to a predetermined third apparatus to store the information; outputting the acquired print job to a predetermined fourth apparatus while maintaining a third security level equal to or higher than the first security level; and outputting the print job in the fourth apparatus to a fifth apparatus set in advance to be capable of being an output destination of the print job from the fourth apparatus based on the information on the print instruction for the print job stored in the third apparatus, to execute print processing in the fifth apparatus.

### (((10)))

A program causing a processor to execute a process for outputting a print job, the the process comprising performing control of: receiving a print instruction for a print job; acquiring, based on the received print instruction for the print job, the print job from a first apparatus in which the print job is stored while maintaining a predetermined first security level; and outputting the acquired print job to a second apparatus configured to execute print processing at a second security level lower than the first security level.

What is claimed is:

1. An information processing system comprising:
a processor configured to perform control of:
receiving a print instruction for a print job;
acquiring, based on the received print instruction for the print job, the print job from a first apparatus in which the print job is registered while maintaining a predetermined first security level; and
outputting the acquired print job to a second apparatus configured to execute print processing at a second security level lower than the first security level.

2. The information processing system according to claim 1, wherein the print job is provided with user information indicating a user who has instructed registration of the print job, and
the processor is configured to perform control of:
acquiring user information indicating a user who has instructed printing of the print job; and
acquiring a print job provided with user information matching the acquired user information.

3. The information processing system according to claim 1, wherein the processor is configured to perform control of:
detecting a candidate apparatus capable of being an output destination of the print job;
determining the detected candidate apparatus as the second apparatus; and
converting the print job into a print job corresponding to a type of the determined candidate apparatus as the second apparatus.

4. The information processing system according to claim 3, wherein the processor is configured to perform control of
repeatedly executing the processing of detecting the candidate apparatus for a predetermined period of time.

5. The information processing system according to claim 3, wherein the processor is configured to,
when a plurality of the candidate apparatuses are detected,
determine any one apparatus, as the second apparatus, in accordance with a predetermined priority.

6. The information processing system according to claim 1, wherein the processor is configured to,
upon generating information related to the print job when performing the control of acquiring and the control of outputting, perform control of deleting the information related to the print job after performing the control of outputting the print job to the second apparatus.

7. The information processing system according to claim 1, wherein the processor is configured to
perform control of executing registration of a print job in a predetermined first location, and
perform control of receiving a print instruction for the print job in a second location different from the first location.

8. The information processing system according to claim 7, wherein the processor is configured to perform control of
causing an apparatus installed in the first location to perform registration of a print job through remote connection from the second location different from the first location while maintaining a security level equal to or higher than the predetermined first security level, and
to receive the print instruction for the print job in the second location.

9. The information processing system according to claim 1, wherein the processor is configured to perform control of:
outputting information on the print instruction for the acquired print job to a predetermined third apparatus to store the information;
outputting the acquired print job to a predetermined fourth apparatus while maintaining a third security level equal to or higher than the first security level; and
outputting the print job in the fourth apparatus to a fifth apparatus set in advance to be capable of being an output destination of the print job from the fourth apparatus based on the information on the print instruction for the print job stored in the third apparatus, to execute print processing in the fifth apparatus.

10. A non-transitory computer readable medium storing a program causing a processor to execute a process for outputting a print job, the process comprising performing control of:
receiving a print instruction for a print job;
acquiring, based on the received print instruction for the print job, the print job from a first apparatus in which the print job is stored while maintaining a predetermined first security level; and
outputting the acquired print job to a second apparatus configured to execute print processing at a second security level lower than the first security level.
